(19) United States
(12) Patent Application Publication
(10) Pub. No.: US 2023/0080777 A1
(43) Pub. Date: Mar. 16, 2023

(54) Power Grid Frequency Stabilization Using Infrastructure of Communications Network

(71) Applicant: Telefonaktiebolaget LM Ericsson (PUBL), Stockholm (SE)

(72) Inventors: Pal FRENGER, LINKÖPING (SE); Marcus TORNQVIST, Göteborg (SE); Erik ERIKSSON, LINKÖPING (SE)

(21) Appl. No.: 17/790,209

(22) PCT Filed: Jan. 23, 2020
(86) PCT No.: PCT/EP2020/051687

§ 371 Date: Jun. 30, 2022

(51) Int. Cl. H02J 3/32; H02J 9/06; H02J 3/00; H02J 7/00

(52) U.S. Cl. CPC H02J 3/32; H02J 9/06; H02J 3/003; H02J 7/0048; H02J 7/0013

(57) ABSTRACT

A method for stabilising a power grid by at least one backup battery of a network element for use in a communications network. The method comprises determining (402) future power consumption of the network element, determining (404) a required backup energy level of said at least one backup battery based on said determined future power consumption for operation of the network element for a defined period and providing (406) a fraction of capacity of said at least one backup battery to stabilise a power grid.

### TECHNICAL FIELD

The present invention relates to stabilising power grid frequency of a communications network, in general, and in particular to methods and devices for using backup batteries in infrastructure of a communications network for stabilising power grid frequency.

### BACKGROUND

In order for the equipment powered by electricity connected to sockets at homes and businesses it is important that the local/national power system is stable and one of the important aspects of this is stability of frequency at which the power grid operates. A power network in a country operates at certain target frequency (in most countries it is either 50 Hz or 60 Hz). Keeping this frequency stable is important because a deviation of only 1% may cause damage to connected appliances or infrastructure. However due to intermittent energy production (e.g. from renewable sources) and time varying power consumption during the day, the grid frequency fluctuates in a random way as illustrated in FIG. 1. With an increasing amount of solar and wind power production this it is becoming increasingly important to have the capacity to stabilize the power grid.

A so called “reactive power” is used to stabilise the grid frequency. At times when power consumption by households and businesses increase the grid frequency slightly drops and this must be compensated by generating more reactive power to the grid, which results in stabilising the grid frequency within the required range of the target frequency. Conversely, when the power consumption drops there is an excess power in the system and the grid frequency fluctuates up from the required range. In this situation, to stabilise the frequency some of the power needs to be absorbed. As mentioned above, with solar and wind generated power the problem of grid stabilisation is even more important because power consumption by household and businesses can be easily predicted (it follows a certain pattern: weekdays, weekend, day, night, etc), but the ability to generate solar and wind power is much harder to predict and control.

### SUMMARY

According to a first aspect of the present invention there is provided a network element for use in a communications network. The network element comprises at least one backup battery, a processing circuitry and a memory. The memory contains instructions executable by the processing circuitry such that the network element is operative to determine future power consumption of the network element and determine a required backup energy level based on said determined future power consumption for operation of the network element for a defined period. Further, the network element is operative to provide a fraction of capacity of said at least one backup battery to stabilise a power grid.

According to a second aspect of the present invention there is provided a centralised backup battery management apparatus for a communications network. The apparatus comprises a processing circuitry and a memory. The memory contains instructions executable by the processing circuitry such that the apparatus is operative to obtain information indicative of the type of grid stabilisation that is required by the power grid and obtain information indicative of charging levels of backup batteries at individual network elements. Further, the apparatus is operative to obtain required backup energy levels for the individual network elements and send control messages to at least part of the network elements based at least on the type of required stabilisation and the charging levels. A control message sent to one network element instructs said network element to provide a fraction of capacity of at least one backup battery of said network element for stabilising the power grid as required by the power grid.

According to a third aspect of the present invention there is provided a method for stabilising a power grid by at least one backup battery of a network element for use in a communications network. The method comprises determining future power consumption of the network element and determining a required backup energy level of said at least one backup battery based on said determined future power consumption for operation of the network element for a defined period. The method also comprises providing a fraction of capacity of said at least one backup battery to stabilise a power grid.

According to a fourth aspect of the present invention there is provided a method for centralised backup battery management for use in a communications network. The method comprises obtaining information indicative of the type of grid stabilisation that is required by the power grid and obtaining information indicative of charging levels of backup batteries at individual network elements and obtaining required backup energy levels for the individual network elements. The method also comprises sending control messages to at least part of the network elements based at least on the type of required stabilisation and the charging levels. A control message sent to one network element instructs said network element to provide a fraction of capacity of at least one backup battery of said network element for stabilising the power grid as required by the power grid.

According to a fifth aspect of the present invention there is provided an add-on apparatus for a communications network element, the network element being capable of being powered from at least one backup battery. The add-on apparatus comprises a processing circuitry and a memory. The memory contains instructions executable by the processing circuitry such that the add-on apparatus is configured to operate according to the method described above in the third aspect.

According to a sixth aspect of the present invention there is provided a communications network configured to operate according to the method defined above.

Further features of the present invention are as claimed in the dependent claims.

The present invention provides the advantage of enabling operators of communications network to put their installed backup batteries to use (as they are most of the time waiting to be used) and capture new revenues by using capacity of these installed backup batteries to provide power grid stabilization services to the power grid, without having to install additional backup battery capacity.

### BRIEF DESCRIPTION OF THE DRAWINGS

The present invention will be understood and appreciated more fully from the following detailed description taken in conjunction with the drawings in which:

FIG. 1 is a chart illustrating grid frequency fluctuations over an arbitrary selected period;

FIG. 2 is a diagram illustrating a network element for a communications network in one embodiment of the present invention;

FIG. 3 is a diagram illustrating centralised backup battery management apparatus for a communications network in one embodiment of the present invention;

FIG. 4-FIG. 8 are flow charts illustrating methods for stabilising a power grid in embodiments of the present invention;

FIG. 9 is a diagram illustrating an add-on apparatus for a communications network element in one embodiment of the present invention;

FIG. 10 illustrates an example of how an energy prediction error can be defined;

FIG. 11 illustrates daily variations of required backup energy as well as an example of selecting a time-varying target energy storage level;

FIG. 12 illustrates daily variations of traffic load in different network deployment scenarios;

FIG. 13 and FIG. 14 are diagrams illustrating a communications network in embodiments of the present invention.

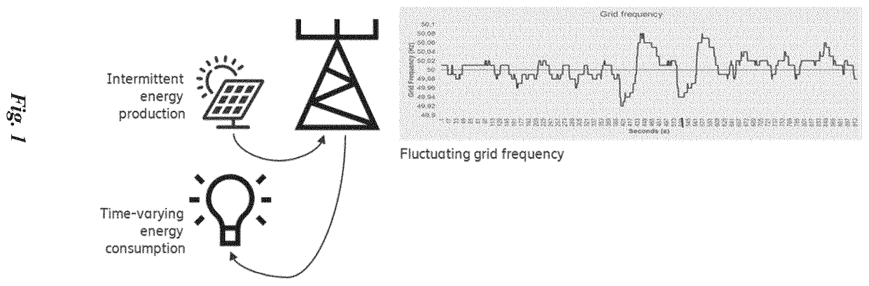

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary details.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

The telecom operators, having a large total battery capacity installed already in their network may use these batteries for generating additional revenue. Radio base stations are required to have backup batteries enough for a few hours of operation at the site in case there is a power grid failure. Because most of the time the power grid works as expected these batteries stay unused all the time the power grid works fine. The present disclosure proposes a solution for using these batteries to stabilise the power grid by putting power back to the grid when the frequency is low, thereby helping to push the grid frequency back to its target value and absorbing power from the power grid (i.e. charging the batteries) when the grid frequency is too high. To achieve any meaningful stabilizing effect requires a large capacity of battery installed nationwide and this is what the telecom operators have already. A communications network could in this way become a virtual power plant (VPP) that provides the critical service of stabilizing the power grid using existing batteries.

Network elements of a communications network, in particular radio base stations (RBS), require backup power for a defined number of hours. How long the RBS is expected to operate on the backup batteries vary in different parts of the world. It is common to install a backup power capacity for a few hours (e.g. 3-5 hours) of operation with no grid power. In case the power failure is longer than that, either the site shuts down, or other on-site power generation is used (such as diesel generators).

The inventors realized that using the backup batteries to stabilize the power grid is not a trivial task, if part of the backup power capacity is to be used for regulating the power grid frequency, then either larger backup-batteries are required (which is expensive) or the actual backup-time may sometimes be below the requirement (and this is not acceptable).

If a grid power failure happens after a period of low grid frequency where backup-batteries have already been working hard trying to lift the grid frequency back up to the target frequency, then the site may not have enough backup power left to remain in operation for the required time (e.g. 3-5 hours). If a power grid failure occurs after a substantial period of low grid frequency the backup batteries are then likely to be partly depleted when they are needed.

Furthermore, when the backup-battery is already fully charged they cannot efficiently store more energy in case the grid frequency becomes high. This is in many situations a minor problem from a grid stabilization point of view, since activating additional power consumption to slow down the grid frequency is much easier than to activate additional energy production. However, if the batteries can be charged only when there is surplus of power in the grid then network operators could be paid when charging the batteries.

The solution disclosed in this document is based on a network element (for example an radio base station) capable of providing fraction of capacity of its backup battery (or batteries) to stabilise the network with a control mechanism that manages charging and discharging of the batteries to stabilise the power grid and maintain the charge level of the batteries that would reduce the likelihood of having the batteries too depleted to power the network element for the required time. The solution is based on determining power consumption in the coming future hours by the network element and based on this prediction determining level of the backup batteries required to power the network element for a defined period of time. In a preferred embodiment the required backup energy level may be increased by a margin to cover for situations when the power consumption would be higher than predicted.

Preferably, the solution, includes also a centralised backup battery management apparatus. The role of this centralised entity is to manage or coordinate using the backup batteries' capacity to stabilise the power grid. The total capacity of the backup batteries installed in a communications network is large, as mentioned before, but it is distributed over a large geographical area. While it is possible that backup battery (or batteries) at an individual network element (e.g. a base station) provide their capacity to stabilise the power grid on their own, i.e. without a centralised backup battery management, it is advantageous that this process is managed centrally and the available spare capacity of the backup batteries aggregated.

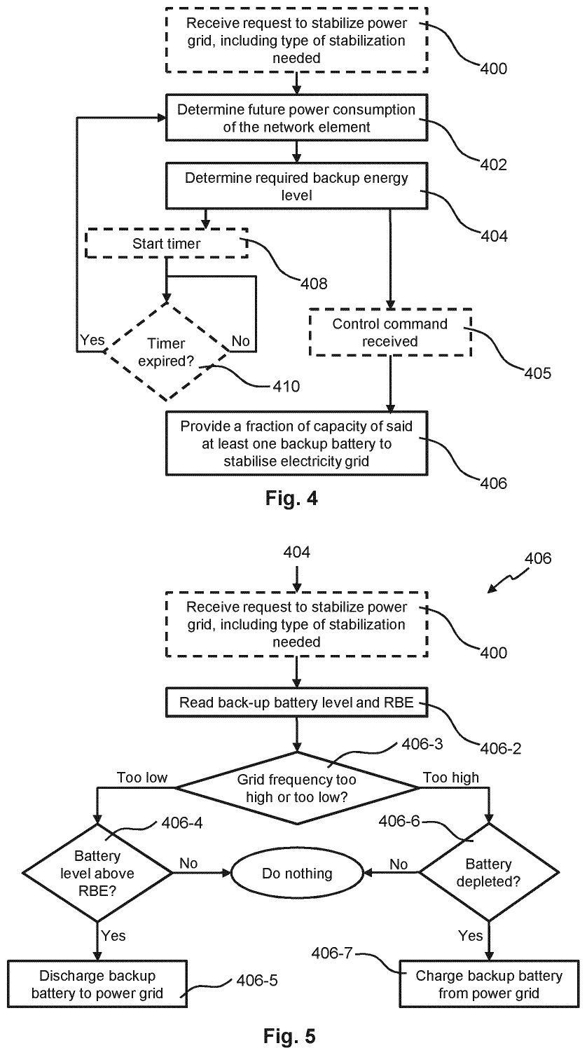

With reference to FIG. 4 one embodiment of a method for stabilising a power grid by at least one backup battery of a communications network element will now be described. Unless specifically stated, this embodiment discloses a standalone solution in which an individual node does not interact with a centralised entity controlling or coordinating the operations of the method.

The method comprises determining, 402, future power consumption of the network element. Based on this future power consumption a required backup energy level (RBE) of said at least one backup battery is determined, 404. The RBE is a value corresponding to a measure of energy stored in the backup batteries of the network element, which should allow operation of the network element on the backup batteries for a defined period (backup period) assuming that the actual power consumption does not exceed the predicted power consumption. In a preferred embodiment the RBE is determined by adding a safety margin which increases the RBE slightly above the value based only on the predicted power consumption. Both, the backup period and the margin are implementation specific. Further, the method comprises providing, 406, a fraction of capacity of said at least one backup battery to stabilise a power grid.

Stabilisation of the power grid may be necessary when the grid frequency is above the target value or when the frequency is below the target value. When the grid frequency is too high the capacity of the backup batteries is used to absorb power from the power grid. In this operation the fraction of capacity of a backup battery does not need to be defined—to help stabilising the network the battery is charged from the power grid and the method uses whatever available capacity a depleted battery may have.

On the other hand, when the grid frequency drops below the target value stabilising the power grid required sending power to the grid and in this embodiment said fraction of capacity the at least one backup battery provided to stabilise the power grid is equal to or less than a difference between a total capacity of said at least one backup battery and the determined required backup energy level (RBE).

FIGS. 4 and 5 show certain operations in dashed lines, this is because they are either optional or may be carried out at other places in the sequence of operations. For example, the prediction of energy consumption, 402, and determining RBE, 404, may be performed in response to a request to stabilise the power grid, 400. Alternatively, the operations 402 and 404 may be performed constantly in a loop, so that the values are constantly updated, e.g. every 15 minutes (controlled by the timer loop 408-410) the power consumption may be predicted and the value of RBE determined.

This embodiment is further disclosed in FIG. 5, which in more detail illustrates the process of providing, 406, the fraction of capacity of said at least one backup battery to stabilise the power grid. The request, 400, to stabilise the power grid received by the network element includes indication of the type of stabilisation that is required, i.e. whether the grid frequency is too low and power needs to be sent to the grid or the grid frequency is too high and some power from the grid needs to be absorbed.

In one embodiment the request, 400, may be received from the power grid (standalone embodiment) or, alternatively, it may be received from a centralised entity controlling or coordinating the operations of the method (centralised embodiment).

Once the request, 400, is received the backup battery level and the RBE of the battery are read, 406-2. If the grid frequency is too low, 406-3, and the backup battery level is above the RBE, 406-4—Yes, the backup battery is discharged 406-5 to the power grid. The discharging stops before the battery level drops to the current RBE value. If the check in step 406-4 shows that the battery level is not above the RBE the network element cannot provide help with stabilising the power grid and the method stops.

If, according to the received request, 400, the grid frequency is too high, 406-3, and the battery is depleted, 406-6—Yes, the backup battery is charged 406-7 from the power grid. In this way a fraction of capacity of said at least one backup battery is charged, 406-7, from the power grid and in this way is used to stabilise said power grid. In an embodiment the network element may be equipped with a solar panel(s) used for charging the backup battery during daytime. In this embodiment the network element switches from charging the backup battery from the solar panel(s) to charging from the power grid.

Preferably, the required backup energy (RBE) is calculated using a worst-case scenario (e.g. assuming 100% load of the network element). Power consumption of a radio base station (RBS) scale with traffic load. In a typical macro base station, the power consumption when there is close to zero traffic is about 50% of the power consumption at full traffic. The traffic load in a radio network varies during the day (and week) in a predictable pattern. Day-time has higher traffic than night-time, and week-days have higher traffic than week ends. Furthermore, there is a significant traffic increase in the network from one year to the next which can also be predicted.

Utilizing this knowledge, the amount of RBE in a site at any time t can be calculated in dependence of the amount of energy required to serve the expected traffic during the required backup time.

In one embodiment, the amount of required backup energy (RBE) as function of time in a radio base station can be calculated as summarized in the following steps:
Divide time in steps of ΔT (e.g. 1-15 minutes). Today most traffic observations are performed on 15-minute time scale which is well suited for this purpose. Average traffic predictions during such a relatively long time period can be made very accurate, while momentary traffic variations around this average are more random.
Let N be the number of time-steps during the required backup time. Determine traffic predictions for every time instance n=1, . . . , N, e.g. {Traffic(t+ΔT), . . . , Traffic(t+NΔT)}.

In case the required backup time is 5 hours and ΔT=15 minutes then N=20.
Determine the average power for every time step ΔT as a function of the predicted traffic (e.g. by using a mathematical power model or a pre-determined look-up table)
Determine the required backup energy (RBE) at time t as

RBE(t)=Σₙ₌₁^{N}Power(Traffic(t+nΔT))×ΔT+margin

The value of the margin may set to a fixed number (e.g. 1-5% of the total capacity) or it may also be time dependent. For example, the absolute uncertainty of the estimated RBE might be higher during high traffic hours than during low traffic hours. In sites where the traffic varies a lot from one day to the next the margin may be increased.

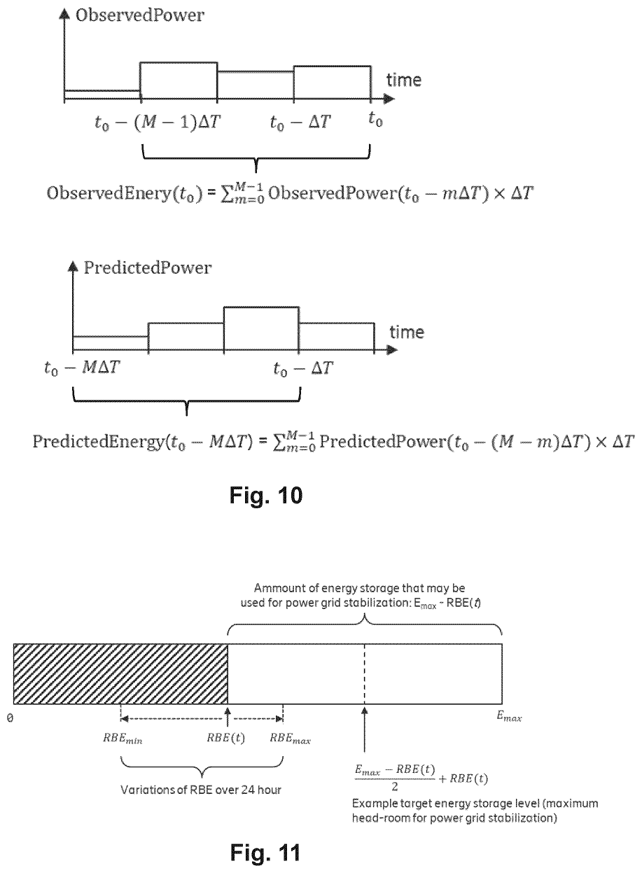

The margin may be determined by an outer-loop algorithm, e.g. by comparing the predicted energy use with the observed actual energy consumption over the same time interval, see FIG. 10. FIG. 10 illustrates an example of how an energy prediction error can be defined. The prediction error could be utilized to determine the required margin when calculating the required backup energy at time t, RBE(t). As illustrated, the prediction error at time to may be expressed as:

EnergyPredictionError(t₀)=ObservedEnergyUse(t₀)−PredictedEnergyUse(t₀−MΔT)

Where M is the number of steps (or time periods) ΔT as explained above in calculating RBE.

If the EnergyPredictionError is positive the margin is increased with a small amount δ and if the margin is negative the margin is decreased with another small amount ε. Preferably, ε should be selected to be smaller than δ since it is more problematic if the PredictedEnergyUse is too small. Note that this is just one example and that there are other known solutions for how to design an outer loop adjustment. Furthermore, the observation time of the outer-loop may be selected independently of the backup-time.

As explained above the energy consumed by a network element is a function of traffic handled by the network element. However, instead of analysing traffic handled, in another embodiment it is possible to base the calculation of RBE directly on predicted energy consumption. Again, the time may be divided into steps of ΔT (e.g. 1-15 minutes) and the same equation may be simplified to:

RBE(t)=Σₙ₌₁^{N}Power(t+nΔT)×ΔT+margin

The advantage of analysing consumed power is that this approach covers different types of nodes and not only radio base stations or other nodes whose energy consumption is a function of the traffic load they handle; for example, RBS sites with edge compute capabilities or other network elements that serve as computational resources and are equipped with backup batteries.

In some embodiments a time-dependent target energy storage level may be determined in such a way so that it allows for maximizing the headroom for grid stabilization. In these embodiments a suitable target value of the target energy storage level could be closer to Eₘₐₓ than what is depicted in FIG. 11 in order to prioritize the capacity to put power back to the grid over the capacity to take power from the grid. The hashed part of the rectangle represents the part of capacity of the backup battery (batteries) that needs to be kept charged and ready for use by the network element in the case of a power failure, i.e. RBE, Eₘₐₓ is the total capacity of the backup battery (batteries) installed at a network element (e.g. RBS site). As the traffic (or computational workload) handled by the network element varies during the day the RBE is also a function of time, i.e. RBE(t). In FIG. 11 it is also schematically shown how the value of RBE(t) varies during the day from a minimum value RBEₘᵢₙ to a maximum value RBEₘₐₓ. The value RBEₘᵢₙ is expected to occur slightly before the lowest traffic (or other workload) is expected and the value RBEₘₐₓ is expected to occur slightly before the peak traffic hours begin.

When determining the fraction of backup battery capacity that can be offered for power grid stabilization factors other than traffic can also be considered, such as:
Battery depletion characteristics. Many batteries are sensitive to being fully discharged. The amount of battery depletion can be determined as function of the battery charge level and included as a factor when determining the RBE.
Special scheduled events (e.g. big concert events in stadium sites) can be a reason for increasing the RBE temporarily, or to take the site off the “virtual power plant” temporarily.
Time varying KPI requirements can be considered. For example, it may be acceptable to de-activate 2G/3G at night in case of a power failure, but not during day time.
AI (artificial intelligence) or ML (machine learning) algorithms are suitable for prediction of not only the mobile network traffic, but also for predicting the grid stabilization requirements.
An acceptance price (for putting power back to grid) can be determined in dependence of e.g:
   The current absolute battery level (e.g. if battery degradation is lower above a certain charging threshold).
   Current battery level in relation to RBE(t).
   Estimates of potential future price for providing grid stabilizing power later, e.g. in case the price for grid stabilizing power is expected to increase in the near future it may be better to use the limited battery power later.
   Cost of service failure. If e.g. a service level agreement (SLA) contains monetary fines for not achieving a certain service level these fines can be taken into account as well. One example is to calculate the estimated cost of current backup power level as the fines defined in SLA×probability of service failure where the probability of a service failure depends on the current backup energy storage level. If this estimated cost is less than the current price offered from the power grid company, then there are economic incentives to temporarily allow for slightly shorter backup-time in case of an unlikely power failure. Sites in un-reliable grid environments may use a higher acceptance price (e.g. they may instead prioritize to always keep the backup power high enough to handle a long power outage).
   An alternative to actively putting power back to the grid is to reduce the power consumed from the grid instead. This also has a stabilizing effect on the power grid. When temporarily utilizing the batteries during normal operation it is still important to maintain the battery storage level above the RBE(t).

Preferably, the future power consumption of a network element is determined, 402, for a period at least as long as the period the network element is expected to operate on the backup batteries. As discussed earlier, the traffic load (and other computational workload handled by the network element) changes with time so the operation of determining performing the future power consumption is performed repetitively, 408, 410. This may be implemented with the use of a timer. After the RBE that is expected to be enough to power the network element for the defined time (e.g. 5 hours) is calculated, step 404, a timer is started, 408, set, for example, for 15 minutes. The process waits until the timer expires, 410, and once expired, 410—yes, the future energy consumption for the next 5 hours is determined and then, similarly, the new value of RBE. As discussed earlier, RBE is a function of time.

If, however, a network element has a constant power consumption, then there is no need to re-calculate its power consumption and RBE repetitively. The power consumption may be constant, for example in case the network element has a load that is always above at or above certain threshold. Also, some network elements may have almost no dependency between workload and power consumption.

In one embodiment, the method comprises operating the network element in a low-power mode when using power from the at least one backup battery.

Because the traffic and computational workload is repetitive, the description already mentioned the daily, weekly and weekend patterns, the future power consumption of said network element may be determined, 402, based on historical data. These historical data may include data on traffic handled or power consumption.

The request to stabilise the power grid, 400, preferably comprises information indicative of the type of grid stabilisation that is required by the power grid. It is not required, however, because in a simple solution the backup batteries installed in network elements may be used only to stabilise one type of grid frequency deviation. The most beneficial is to stabilise the power grid when the grid frequency drops below the target value and if the solution implemented provides only this kind of support for power grid stabilisation then the request does not need to specify what type of grid stabilisation that is required. Stabilising the network when the grid frequency is too high is easier because it requires absorbing some power from the grid, which means that even if the communications network offers only stabilising power grid when the grid frequency is too low the communications network offers a solution that is highly beneficial for the power grid.

In a preferred embodiment the method comprises receiving information indicative of future expected grid frequency. This embodiment is applicable to both standalone and centrally controlled solutions. The power grid also experiences fluctuations of consumed and produced power. The consumed power fluctuates in repetitive patterns (day/night, weekday/weekend, etc.) and the management system of the power grid know these patterns. Power production also fluctuates and while power from coal/gas/nuclear power stations may be controlled it is much harder to predict power production from renewable sources. However, weather forecasts may help with this task and based on combined information related to expected fluctuation of power consumption and power production the management system of the power grid may predict how the grid frequency is likely going to change. With this information, the standalone network elements as well as centralised solutions may plan when to charge and discharge the backup batteries.

When implemented as part of a centralised system, the method comprises receiving a control command, 405, activating the network element to stabilise the power grid, 406. In this embodiment the individual network element may still determine its future power consumption and the required backup energy level, and then wait for a command from a centralised backup battery management apparatus instructing it to provide a fraction of capacity of its backup battery to stabilise the network. This embodiment does not require the network element to carry out the operations illustrated in FIG. 5.

In one embodiment, when the grid frequency drops below the target value, the method may comprise switching from using power from the power grid to using power from the backup batteries to provide a fraction of capacity of said at least one backup battery to stabilise the power grid. In this embodiment the backup battery is used to power the network element instead of the power grid even though there is no power grid failure. The stabilisation effect is the same or almost the same as in the embodiment disclosed earlier, the power is not taken from the power grid, the power grid load is reduced, and this helps increasing the grid frequency.

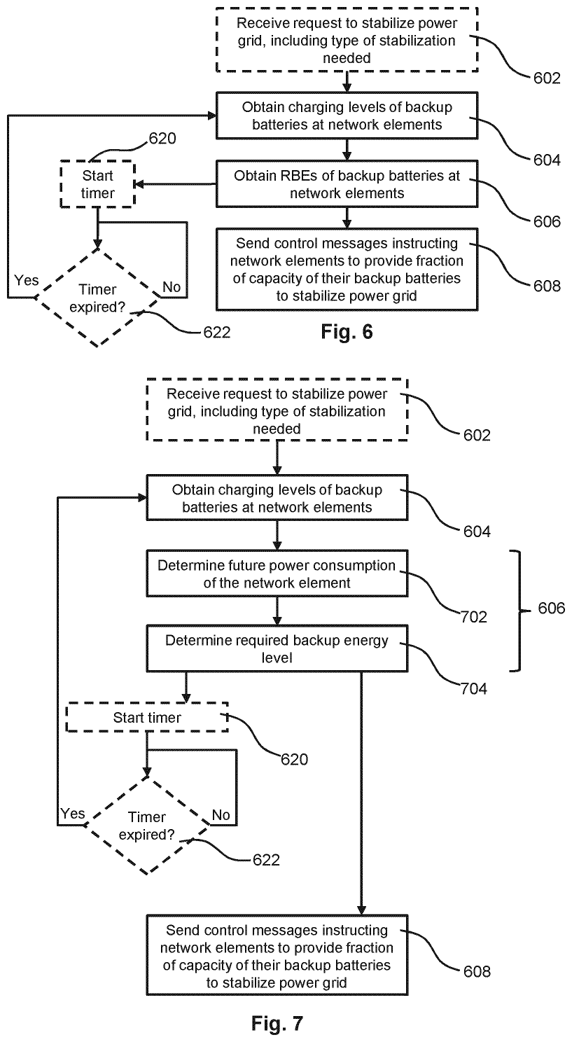

FIG. 6 illustrates an embodiment of a method for centralised backup battery management for use in a communications network. As in the embodiments disclosing the standalone solution operating at an individual network element, also in the centralised approach the backup batteries installed at network elements are used to stabilise power grid. The centralised embodiments described in this document benefit from the large number of backup batteries and their large total capacity as well as from their geographical distribution across large area (e.g. country).

In the embodiment illustrated in FIG. 6 the method for centralised backup battery management comprises obtaining, 602, information indicative of the type of grid stabilisation that is required by the power grid (i.e. indicates whether the grid frequency is too high or too low). Preferably the management system (or systems) of the power grid sends a request to stabilise the power grid and also indicate whether the grid frequency is too high or too low. Alternatively, the centralised backup battery management may measure the grid frequency and based on the result of the measurement decide what type of grid stabilisation is needed. In yet another alternative embodiment the results of grid frequency measurements may be obtained by the centralised backup battery management from some external device.

The method also comprises obtaining, 604, information indicative of charging levels of backup batteries at individual network elements and required backup energy levels (RBEs), 606, for the individual network elements. In one embodiment a centralised backup battery management apparatus (a centralised entity for short), which implements this method, reads RBE values determined by individual network elements and their corresponding backup battery levels. In a preferred embodiment the charging levels and the RBE values may be obtained, 604 and 606, periodically based on operation of a timer, 620 and 622. Alternatively, the charging levels and the RBE values may be obtained upon request.

The method further comprises sending control messages, 608, to at least part of the network elements based at least on the type of the required stabilisation type and the charging levels of backup batteries at the network elements. A control message sent to one network element instructs said network element to provide a fraction of capacity of at least one backup battery of said network element for stabilising the power grid as required by the power grid.

This embodiment works with network elements operating according to an embodiment of the method as illustrated in FIG. 4 in which a control command is received, 405, by an individual network element and this command activates the network element to stabilise the power grid, 406.

An alternative embodiment of the method is illustrated in FIG. 7. The operation of obtaining the required backup energy levels for individual network elements, 606, performed at the centralised entity comprises determining, 702, future power consumption of individual network elements considering at least one of network traffic to be handled by said individual network elements and computational load of said individual network elements. The centralised entity implementing an embodiment of this method may obtain historical information about traffic and other workload (e.g. computational load) handled by the network elements or power consumed by the individual network elements from a network management system of the communications network and determine the future power consumption, 702, of said individual network elements based on historical data.

Instead of reading the required backup energy levels for individual network element determined by the individual network elements the embodiment comprises determining, 704, said required backup energy levels based on said determined future power consumption of the individual network elements expected for operation of the individual network elements for a defined period (backup period).

Also, in this embodiment a timer loop 620 and 622 may be used to periodically obtain the charging levels of individual backup batteries as well as determine the future power consumption of the network elements, 702, and the required backup energy levels (RBEs) of backup batteries at individual network elements.

Similar to the standalone embodiment illustrated in FIG. 4, also the centralised embodiment may operate with certain operations being carried out in more than one sequence order. For example, the operations of obtaining charging levels, 604, and obtaining the RBEs values, 606, may be performed in response to a request to stabilise the power grid, 602, and this includes an embodiment in which these values are obtained periodically using the timer, 620 and 622. In alternative embodiment, these values (charging levels and RBEs) may be obtained periodically using the timer 620 and 622, while waiting for a request to stabilise the power grid, 602.

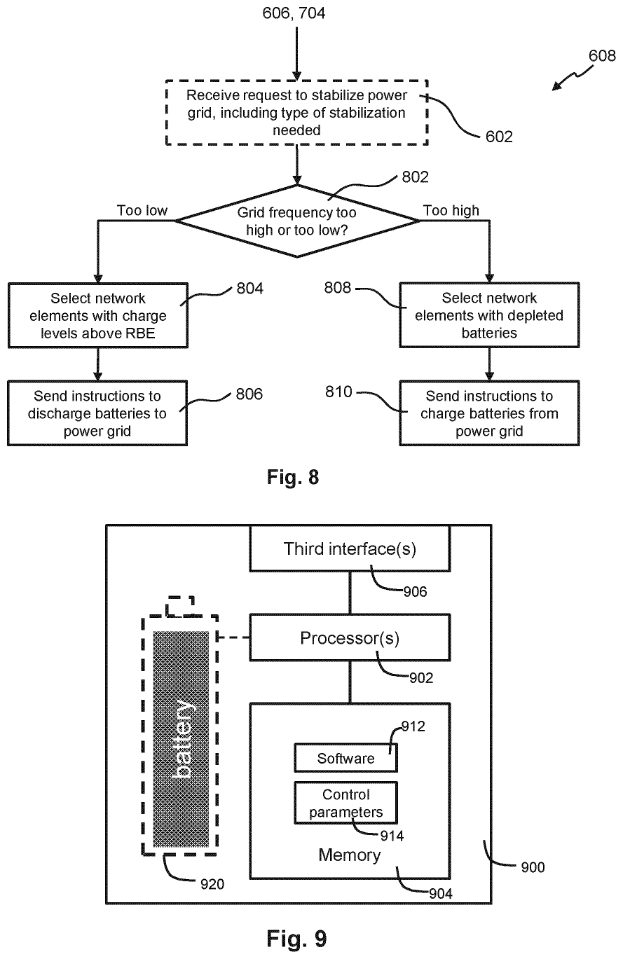

FIG. 8 illustrates an embodiment in which the operations of obtaining charging levels, 604, and the RBEs values, 606, (including the option with operations 702 and 704) are carried out repetitively even in an absence of a request to stabilise the power grid. In one embodiment the centralised entity has the most recently obtained values of charging levels and RBEs when the request to stabilise the power grid is received, 602. The request includes information indicative of the type of stabilisation needed. Alternatively, the request to stabilise the power grid including information indicative of the type of stabilisation needed is received, 602, before the charging levels, 604, and the RBEs values, 606, are obtained.

If the grid frequency is too low (i.e. below the target frequency), 802—too low, the method comprises selecting network elements with charging levels above their respective RBEs, 804. When the charging level of a backup battery is above its RBE then the surplus above RBE may be used to stabilise the network. Then the method comprises sending, 806, instructions to the selected individual network elements to use fractions of capacity of their backup batteries to provide power to the power grid by discharging the backup batteries to the power grid. The discharging process stops before the backup battery charging level drops below the RBE.

If the grid frequency is too high (i.e. above the target frequency), 802—too high, the method comprises selecting, 808, network elements with depleted backup batteries. The method further comprises sending, 810, instructions to use fractions of capacity of said backup batteries at the individual network elements to charge the backup batteries from the power grid to stabilise said power grid. Preferably, the charging process stops when the backup battery is fully charged. In an embodiment at least some of the network elements may be equipped with solar panels used for charging their backup batteries during daytime. In this embodiment, when instructed to use to use a fraction of capacity of its backup battery to stabilise the grid, the individual network element switches from charging the backup battery from the solar panel(s) to charging from the power grid.

FIGS. 6, 7 and 8 show certain operations in dashed lines, this is because they are either optional or may be carried out at other places in the sequence of operations.

In a preferred embodiment the control message sent to an individual network element in operation 608 (this includes the instruction sent in operations 806 and 810) defines the fraction of capacity of said at least one backup battery for use in stabilising the power grid to be equal to or less than a difference between a total capacity of said at least one backup battery and the determined required backup energy level. This is only optional, first because if the stabilising operation requires charging the batteries there is no need to observe the RBE, the batteries may be charged irrespective of their RBEs if they are depleted. Second, if the predicted power consumption and RBE are determined at the individual network elements then the information about the fraction available for stabilising is already at network elements.

The method preferably comprises determining the future power consumption, 702, of said individual network elements for a period at least as long as said defined period. As explained earlier, the operation of determining the future power consumption is preferably performed repetitively, 620 and 622. As discussed earlier, the traffic load (and other computational workload handled by the network element) changes with time so the operation of determining performing the future power consumption is performed repetitively, 620, 622 for individual network elements. Preferably, in the centralised entity a separate process runs for each network element which has backup batteries used for power grid stabilisation. After the RBE values are obtained, steps 606 or 704, a timer is started, 620, set, for example, for 15 minutes. The process waits until the timer expires, 622, and once expired, 622—yes, the values of future energy consumption by individual network elements for the next 5 hours are determined and then, similarly, the new values of RBE are determined too.

Preferably, the method comprises receiving information indicative of future expected grid frequency. This information is received by the centralised entity preferably from a management system (or systems) of the power grid. More details about power consumption and power production patterns were discussed earlier and are applicable here as well. The method preferably comprises instructing the individual network elements to charge and discharge their backup batteries based on the received information indicative of future expected grid frequency.

In yet another alternative embodiment, when the grid frequency is too low, the control message sent by the centralised entity to an individual network element may comprise an instruction to switch the network element from using power from the power grid to using power from the backup batteries. In this way a fraction of capacity of at least one backup battery of said network element is provided for stabilising the power grid as required by the power grid. In this embodiment the backup battery is used to power the network element instead of the power grid even though there is no power grid failure. The stabilisation effect is the same or almost the same as in the embodiment disclosed earlier, the power is not taken from the power grid, the power grid load is reduced, and this helps increasing the grid frequency.

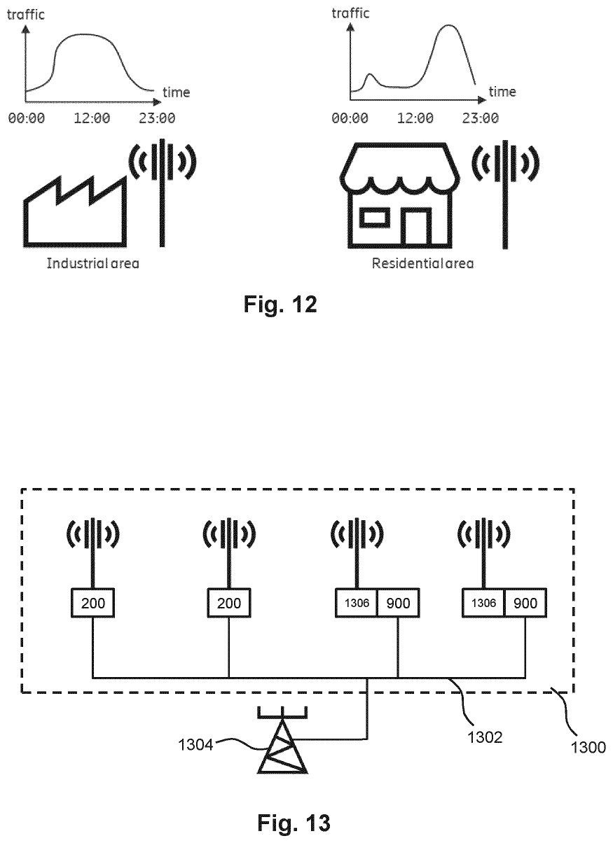

As explained earlier mobile phone users move in the network during the day and so does the traffic. Hence peak hour traffic occurs at different times in different sites (residential, industry, office, mall, stadium) creating certain patterns that repeat in time, see FIG. 12. For power grid stabilization this means that a properly deployed network will always be able to provide capacity for grid stabilization even though individual sites may not have enough backup battery capacity. This is why the centralised approach is particularly advantageous.

The amount of grid stabilizing energy storage that the network can offer for grid stabilization at any time t can hence be calculated as

$${E}_{n w} ( t ) = {\sum }_{i = 1}^{I} {E}_{max}^{i} - {RBE}^{i} ( t )$$

where Eₘₐₓⁱ is the maximum energy storage in base station i, RBEⁱ(t) is the required backup energy in base station i at time t, and I is the total number of sites in the network that have backup batteries and are coordinated by solution as described in this document. The minimum value of E_{nw}(t) for any time t is denoted E_{min,nw} and this value represents the total available grid stabilization capacity of all batteries in the whole network.

In case the total power grid stabilization capacity of the whole radio network is more than what is currently required in order to stabilize the power grid then the centralised entity in the communications network may be used to dynamically determine which network element (e.g. radio base station) that shall reserve backup-battery capacity for use in power grid stabilization. The decision made by the centralised entity may be based considering one or more of the following factors for individual network element:
the expected future traffic (during a backup-time window),
the expected future computational load (during a backup-time window),
the time-dependent required backup energy,
the current charging level of the backup-batteries,
the backup battery total capacity,
the type of backup battery (e.g. lithium-based batteries can charged and discharged much more often and much deeper than lead-acid batteries),
the geo-location of the radio base station,
the power grid frequency measured at the radio base station or close to the geo-location of said base station,
Information related to local power consumption and local power production in the vicinity of the geo-location of the radio base station,
existence of local power production capacity (e.g. on-site diesel, wind, solar power, etc),
state of local power production and storage (e.g. diesel tank level, solar and wind predictions, etc), etc.

The centralized entity in the communications network can dynamically control the utilization of the combined power-grid stabilization contributions provided by all participating network elements in the communications network.

A typical method of combining entities of different units (as in the list above) for selecting network elements for providing fractions of capacity of their backup batteries is to define a utility function using scaling and normalization factors for each entity. When comparing possible operational states, the one with the highest utility is considered to be superior. Determining the scaling factors of such a network wide utility function requires some trial-and-error and could e.g. be done using a machine learning algorithm.

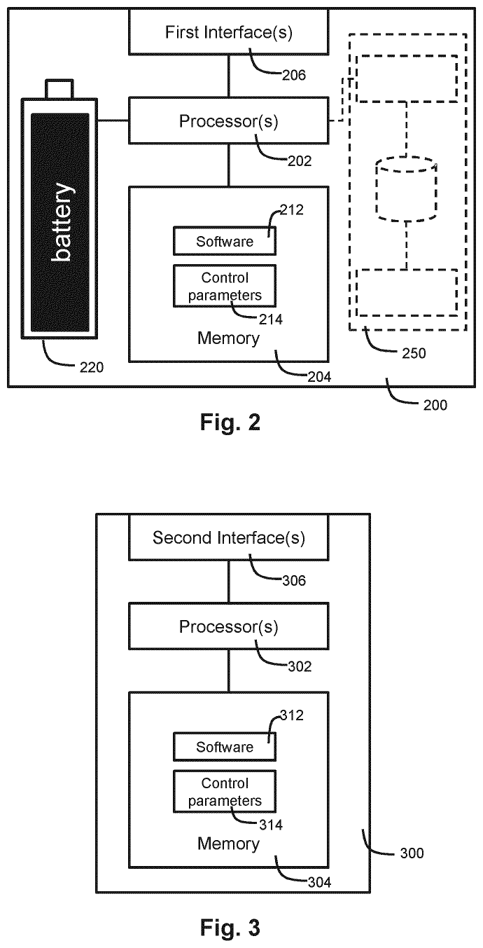

FIG. 2 illustrates one embodiment of a network element, 200, for use in a communications network which implements the method for stabilising a power grid by at least one backup battery installed at said network element and described earlier. The network element, 200, comprises at least one backup battery, 220, a processing circuitry, 202, and a memory, 204. The memory, 204, contains instructions executable by the processing circuitry, 202, such that the network element, 200, is operative to determine future power consumption of the network element, 200, and determine a required backup energy level (RBE) based on said determined future power consumption. The required backup energy level is expected to maintain operation of the network element, 200, for a defined period. The network element, 200, is also operative to provide a fraction of capacity of said at least one backup battery to stabilise a power grid.

By predicting the power consumption for the several hours ahead (at least for the time span of the defined period) it is possible to determine the amount of the energy stored in the backup batteries to power the network element for as long as the defined period (backup period). This assumes that the power consumption will not exceed the prediction, for example, if the prediction was based on the traffic handled by the network element, the batteries should last for the backup period if the traffic will not exceed the prediction. If the actual power consumption is above the predicted one then we risk network element powering down (cell(s) outage if the network element is a radio base station). To increase the prolong operation on the backup batteries the network element may switch to low power mode by turning off some low priority services, e.g. supporting a network slice serving electricity meters may be disabled.

The network element, 200, may include a processing circuitry (one or more than one processor), 202, communicating with a first interface, 206. The network element, 200, may comprise more than one interface. For example, one interface may an interface for connecting to other elements of the communications network and another interface may be provided for the communicating messages related to the method for stabilising the power grid. The network element may provide support in stabilising the power grid in a standalone approach or in centralised approach described earlier. In one embodiment a request, 400, to stabilise the power grid may be received from the power grid (standalone embodiment) or, alternatively, it may be received from a centralised entity controlling or coordinating the operations of the method (centralised embodiment). The request is preferably received via the first interface.

The network element, 200, may comprise other components not described here and collectively shown in FIG. 2 as 250. These other components are not essential to the operation of the invention. For example, if the network element is a radio base station the network element may also comprise an antenna and other components required for operation as designed for the specific type of network element. A different set of these additional components will be present in a switch, a router or a core network element.

By way of example, the first interface 206, the processor(s) 202, and the memory 204 may be connected in series as illustrated in FIG. 2. Alternatively, these components 202, 204 and 206 may be coupled to an internal bus system of the network element, 200. The memory 204 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory, 204, may include software, 212, and/or control parameters, 214. The memory, 204, may include suitably configured program code to be executed by the processor(s), 202, so as to implement the above-described method as explained in connection with FIGS. 4, 5 and 10-12.

The connection between the backup battery 220 and the processor 202 is not a connection for powering the processor 202 or the network element. The connection is for controlling the operation of the backup battery, 220, in accordance with the embodiments of the methods described in this document.

FIG. 9 illustrates one embodiment of an add-on apparatus, 900, for a communications network element. The network element is capable of being powered from at least one backup battery and this backup battery (batteries) may be used for power grid stabilisation whereas the add-on apparatus, 900, implements the method for stabilising a power grid by the at least one backup. In one embodiment, the add-on apparatus may comprise the at least one backup battery, 920, or, alternatively, the add-on apparatus may be provided without its own backup battery and work with battery (batteries) already installed at a network element. The add-on apparatus, 900, comprises a processing circuitry, 902, and a memory, 904 and a third interface. The memory, 904, contains instructions executable by the processing circuitry, 902, such that the add-on apparatus, 900, is configured to operate according to the method described earlier and illustrated in FIGS. 4, 5 and 10-12.

The add-on apparatus, 900, may include a processing circuitry (one or more than one processor), 902, communicating with the third interface, 906. The add-on apparatus, 900, may comprise more than one interface. The third interface, 906, may be provided for the communicating messages related to the method for stabilising the power grid. These messages may be exchanged with the power grid and/or with a centralised entity, 300, managing the process of stabilising the power grid by the backup batteries. The add-on apparatus, 900, is a device that may be retrofitted to existing network elements that comprise backup batteries but are not capable of participating in the process of power grid stabilisation. In alternative embodiments, the add-on apparatus, 900, comprises its own battery, 920, and it may be retrofitted to existing network elements which do not have backup batteries or, in yet another embodiment, the add-on apparatus, 900, may be used to replace backup batteries in existing network elements. The add-on apparatus may provide support in stabilising the power grid in a standalone approach or in centralised approach described earlier. In one embodiment a request, 400, to stabilise the power grid may be received from the power grid (standalone embodiment) or, alternatively, it may be received from a centralised entity controlling or coordinating the operations of the method (centralised embodiment). The request is preferably received via the third interface 906.

By way of example, the third interface 906, the processor(s) 902, and the memory 904 may be connected in series as illustrated in FIG. 9. Alternatively, these components 902, 904 and 906 may be coupled to an internal bus system of the add-on apparatus, 200. The memory 904 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory, 904, may include software, 912, and/or control parameters, 914. The memory, 904, may include suitably configured program code to be executed by the processor(s), 902, so as to implement the above-described method as explained in connection with FIGS. 4, 5 and 10-12.

FIG. 3 illustrates one embodiment of a centralised backup battery management apparatus, 300, also referred to as centralised entity for short. The centralised entity, 300, is for use in a communications network which implements the method for stabilising a power grid by at least one backup battery installed at at least one network element and described earlier. The centralised entity, 300, comprises a processing circuitry, 302, and a memory, 304. The centralised entity, 300, also comprises a second interface (or plurality of interfaces), 306, for communicating with a plurality of network elements comprising backup batteries and with the power grid. The memory, 304, contains instructions executable by the processing circuitry, 302, such that the network element, 300, is operative to obtain via the second interface, 306, information indicative of the type of grid stabilisation that is required by the power grid and further obtain via the second interface, 306, information indicative of charging levels of backup batteries at individual network elements. The centralised entity, 300, is also operative to obtain via the second interface, 306, required backup energy levels for the individual network elements. When the charging levels and the required backup energy levels are known the centralised entity, 300, is operative to send control messages to at least part of the network elements based at least on the type of required stabilisation and the charging levels. A control message sent to one network element instructs said network element to provide a fraction of capacity of at least one backup battery of said network element for stabilising the power grid as required by the power grid.

As explained earlier, the grid stabilisation may be required when the grid frequency drops below the target value and when the grid frequency increases above the target value (of course, there is some range of allowed deviation of the grid frequency from the target value). When the grid frequency is higher than the target value the required backup energy levels may not need to be considered when instructing the individual network elements. To stabilise the power grid the backup batteries are charged, so the centralised entity, 300, selects the depleted backup batteries (or partially or totally discharged) and instructs the selected network elements, 200, to charge their backup batteries. In this embodiment it is not necessary to determine and communicate the size of the fraction of capacity of a backup battery for stabilising the power grid because the selected backup battery will be charged irrespective of its initial charging level.

On the other hand, when the grid stabilisation is required due to the grid frequency dropping below the target frequency a control message sent to an individual network element defines the fraction of capacity of the backup battery (batteries) of the individual network element for use in stabilising the power grid to be equal to or less than a difference between a total capacity of said at least one backup battery and the determined required backup energy level. In this way the backup batteries will not be discharged below the current RBE. RBE is a function of time as discussed earlier.

By way of example, the second interface(s) 306, the processor(s) 302, and the memory 304 may be connected in series as illustrated in FIG. 3. Alternatively, these components 302, 304 and 306 may be coupled to an internal bus system of the centralised entity, 300. The memory 304 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory, 304, may include software, 312, and/or control parameters, 314. The memory, 304, may include suitably configured program code to be executed by the processor(s), 302, so as to implement the above-described method as explained in connection with FIGS. 6-8 and 10-12.

The centralised entity, 300, in its embodiments may control and coordinate operation of network elements, 200, or add-on apparatus, 900, installed in network elements.

It is to be understood that the structures as illustrated in FIGS. 2, 3 and 9 are merely schematic and that the apparatus, 200, 300 and 900 may actually include further components which, for the sake of clarity, have not been illustrated, e.g., further interfaces or processors. Further, in practical implementations the units responsible for battery backup comprise rectifiers and inverters and other components necessary for providing power to the power grid from the batteries. The first, second and third interfaces, 206, 302 and 906 allow for communicating with the power grid as well as with other devices operating in the communications network and participating in stabilising the power grid. Also, it is to be understood that the memory, 204, 304, 904 may include further program code for implementing other and/or known functionalities.

According to some embodiments, also a computer program may be provided for implementing functionalities of the apparatus, 200, 300 and 900, e.g., in the form of a physical medium storing the program code and/or other data to be stored in the memory 204, 304, 904, or by making the program code available for download or by streaming.

It is also to be understood that the apparatus, 200, 300 and 900, may be provided as a virtual apparatus. In one embodiment, the apparatus, 200, 300 and 900, may be provided in distributed resources, such as in cloud resources. When provided as virtual apparatus, it will be appreciated that the memory, 204, 304, 904, processing circuitry, 202, 302 and 902, and first, second and third interfaces, 206, 302 and 906 may be provided as functional elements. The functional elements may be distributed in a logical network and not necessarily be physically connected. It is also to be understood that the apparatus, 200, 300 and 900, may be provided as single-node devices, or as a multi-node system.

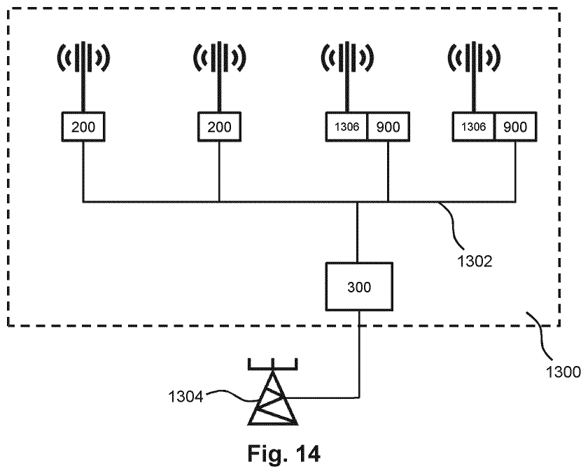

FIGS. 13 and 14 illustrate embodiments of a communications network, 1300, using devices and methods according to embodiments described in this document. In FIG. 13, the network elements, 200, or add-on apparatus, 900, retrofitted to network elements, 1306, operate as standalone elements and receive from the power grid 1304 requests to stabilise the power grid. Preferably, the power provided to or taken from the grid is transported over another connect, which is not illustrated in this figure.

FIG. 14, illustrates the communications network, 1300, operating with the centralised entity, 300. The centralised entity, 300, is presented as part of the communications network, 1300, but in alternative embodiments it may be implemented as part of the power grid 1304. In yet another alternative of the centralised embodiment the network elements or add-on apparatus may simply provide to the centralised entity information indicative of their current level of backup batteries and be operative to send power to the grid, 1304, or take power from the grid in response to instructions from the centralised entity, 300.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A network element for use in a communications network, the network element comprising at least one backup battery, a processing circuitry and a memory, the memory containing instructions executable by the processing circuitry such that the network element is operative to:
determine future power consumption of the network element;
determine a required backup energy level based on said determined future power consumption for operation of the network element for a defined period; and
provide a fraction of capacity of said at least one backup battery to stabilize a power grid.

2. The network element according to claim 1, wherein said fraction of capacity of said at least one backup battery provided to stabilize the power grid is equal to or less than a difference between a total capacity of said at least one backup battery and the determined required backup energy level.

3. The network element according to claim 2 operative to use said fraction of capacity of said at least one backup battery to provide power to the power grid to stabilize said power grid when the grid frequency drops below a target value.

4. The network element according to claim 1 operative to use said fraction of capacity of said at least one backup battery to charge the at least one backup battery from the power grid to stabilize said power grid when the grid frequency exceeds a target value.

5. The network element according to claim 1 operative to work in a low-power mode when using power from the at least one backup battery.

6. The network element according to claim 1 operative to determine the future power consumption of said network element considering at least one of network traffic to be handled by said network element and computational load of said network element.

7. The network element according to claim 1 operative to determine the future power consumption of said network element based on historical data.

8.-13. (canceled)

14. A centralized backup battery management apparatus for a communications network, the apparatus comprising: a processing circuitry and a memory a power grid, wherein the memory contains instructions executable by the processing circuitry such that the apparatus is operative to:
obtain information indicative of the type of grid stabilization that is required by the power grid;
obtain information indicative of charging levels of backup batteries at individual network elements;
obtain required backup energy levels for the individual network elements;
send control messages to at least part of the network elements based at least on the type of required stabilization and the charging levels, wherein a control message sent to one network element instructs said network element to provide a fraction of capacity of at least one backup battery of said network element for stabilizing the power grid.

15. The centralized backup battery management apparatus according to claim 14 further operative to:
determine future power consumption of individual network elements;
wherein to obtain the required backup energy levels for the individual network elements the apparatus is operative to determine the required backup energy levels for the individual network elements based on said determined future power consumption of said individual network elements for operation of said individual network elements for a defined period.

16. The centralized backup battery management apparatus according to claim 14 or, wherein a control message sent to an individual network element defines the fraction of capacity of said at least one backup battery for use in stabilizing the power grid to be equal to or less than a difference between a total capacity of said at least one backup battery and the determined required backup energy level.

17. (canceled)

18. The centralized backup battery management apparatus according to claim 14 operative to send instructions to use fractions of capacity of said backup batteries at the individual network elements to charge the backup batteries from the power grid to stabilize said power grid when the grid frequency exceeds a target value.

19. The centralized backup battery management apparatus according to claim 15 operative to determine the future power consumption of said individual network elements considering at least one of network traffic to be handled by said individual network elements and computational load of said individual network elements.

20. The centralized backup battery management apparatus according to claim 15 operative to determine the future power consumption of said individual network elements based on historical data.

21.-23. (canceled)

24. A method for stabilizing a power grid by at least one backup battery of a network element for use in a communications network, the method comprising:
determining future power consumption of the network element;
determining a required backup energy level of said at least one backup battery based on said determined future power consumption for operation of the network element for a defined period; and
providing a fraction of capacity of said at least one backup battery to stabilize a power grid.

25. The method according to claim 24, wherein said fraction of capacity of said at least one backup battery provided to stabilize the power grid is equal to or less than a difference between a total capacity of said at least one backup battery and the determined required backup energy level.

26. The method according to claim 24 comprising using said fraction of capacity of said at least one backup battery to provide power to the power grid to stabilize said power grid when the grid frequency drops below a target value.

27. The method according to claim 24 comprising using said fraction of capacity of said at least one backup battery to charge the at least one backup battery from the power grid to stabilize said power grid when the grid frequency exceeds a target value.

28. The method according to claim 24 comprising operating the network element in a low-power mode when using power from the at least one backup battery.

29. The method according to claim 24 comprising determining the future power consumption of said network element for a period at least as long as said defined period and performing the operation of determining the future power consumption repetitively.

30. The method according to claim 24 comprising determining the future power consumption of said network element considering at least one of network traffic to be handled by said network element and computational load of said network element.

31.-37. (canceled)

38. A method for centralized backup battery management for use in a communications network, the method comprising:
obtaining information indicative of the type of grid stabilization that is required by the power grid;
obtaining information indicative of charging levels of backup batteries at individual network elements;
obtaining required backup energy levels for the individual network elements;
sending control messages to at least part of the network elements based at least on the type of required stabilization and the charging levels, wherein a control message sent to one network element instructs said network element to provide a fraction of capacity of at least one backup battery of said network element for stabilizing the power grid.

39. The method according to claim 38 further comprising:
determining future power consumption of individual network elements; and
wherein the operation of obtaining the required backup energy levels for the individual network elements comprises determining said required backup energy levels based on said determined future power consumption of said individual network elements for operation of said individual network elements for a defined period.

40.-51. (canceled)
